(19) United States
(12) Patent Application Publication
(10) Pub. No.: US 2013/0338943 A1
(43) Pub. Date: Dec. 19, 2013

(54) METHOD FOR OPERATING A RESONANCE MEASURING SYSTEM AND A RESONANCE MEASURING SYSTEM IN THIS REGARD

(71) Applicant: KROHNE MESSTECHNIK GMBH, Duisburg (DE)

(72) Inventors: Kourosh KOLAHI, Duisburg (DE); Ralf STORM, Essen (DE)

(73) Assignee: KROHNE MESSTECHNIK GMBH, Duisburg (DE)

(21) Appl. No.: 13/659,304

(22) Filed: Oct. 24, 2012

(30) Foreign Application Priority Data
Jun. 18, 2012 (DE) 10 2012 011 934.8

(51) Int. Cl. G01F 1/84; G06F 15/00

(52) U.S. Cl. CPC G01F 1/8436; G06F 15/00
USPC 702/46; 702/56

(57) ABSTRACT

Methods and systems are provided for operating a resonance measuring system, including a Coriolis mass flow meter. The resonance measuring system includes an electrical actuating apparatus, an electromagnetic drive, and an oscillation element which interacts with a medium. The electrical actuating apparatus provides an electrical excitation signal that excites the electromagnetic drive. The electromagnetic drive excites the oscillation element to oscillation. A mathematical model of the resonance measuring system depicts the oscillation element and the parameters of the mathematical model are being identified excitation of the oscillation element. The identified parameters and quantities are used for operating the resonance measuring system.

### BACKGROUND OF THE INVENTION

1. Field of the Invention

The invention relates to a method for operating a resonance measuring system, especially a Coriolis mass flow meter. The resonance measuring system comprising at least one electrical actuating apparatus, at least one electromagnetic drive as an oscillation generator, at least one oscillation element which interacts with a medium. The electrical actuating apparatus provides an electrical excitation signal for exciting the electromagnetic drive. The electromagnetic drive excites the oscillation element to oscillation in at least one natural form. A mathematical model of the resonance measuring system, which depicts at least the oscillation element, is set up and the parameters of the mathematical model are identified by suitable excitation of the oscillation element and evaluation of the mathematical model. The identified parameters and/or quantities derived therefrom are used for operation of the resonance measuring system.

2. Description of Related Art

Resonance measuring systems of the aforementioned type have been known for many years, not only in the form of Coriolis mass flow meters, but also as density measuring devices or liquid level monitors according to the tuning fork principle, as crystal trucks and band viscosimeter and the like. These resonance measuring systems are connected to a process/process medium, wherein the process and process medium and resonance measuring system mutually influence one another.

Resonance measuring systems are treated below using the example of Coriolis mass flow meters, which should not be understood as limiting. It is irrelevant whether they are Coriolis mass flow meters with one or more measurement tubes, with straight or bent measurement tubes. Resonance measuring systems here are quite generally systems in which information about the process quantities (measurement quantities) to be determined are encrypted in the natural frequencies and/or systems in which working points are placed on the natural frequencies of the measurement systems. The following disclosure can be applied to all the systems that fall under this definition. In Coriolis mass flow meters, the measurement tube corresponds to the oscillation element of the resonance measuring system. This special configuration of the oscillation element does not constitute a limitation for the teaching that can be applied in general to the resonance measuring systems either.

Resonance measuring systems which are made as Coriolis mass flow meters are used mainly in industrial process measurement engineering wherever mass flows must be determined with high precision. The manner of operation of Coriolis mass flow meters is based on at least one measurement tube through which a medium flows, in which an oscillation element is excited to oscillation by an oscillation generator. This oscillation generator is presumably an electromagnetic drive. In this electromagnetic drive, conventionally, an electrical current flows through the coil. The action of a force on the oscillation element is connected to the coil current. In Coriolis mass flow meters, the manner of operation is based on the fact that the mass-burdened medium due to the Coriolis inertial force caused by two orthogonal movements, i.e., that of flow and that of the measurement tube, reacts on the wall of the measurement tube. This reaction of the medium on the measurement tube leads to a change of the measurement tube oscillation compared to the oscillation state of the measurement tube without throughflow. By detecting these particulars of the oscillations of the Coriolis measurement tube through which flow has taken place, the mass flow rate can be determined by the measurement tube with high precision.

The natural frequencies of the Coriolis mass flow meter or of the oscillatory parts of the Coriolis mass flow meter (essentially, therefore, the natural frequencies of the measurement tube as an oscillation element), are of special importance because the working points of the Coriolis mass flow meter are usually placed at the natural frequencies of the measurement tube in order to be able to cause the required oscillations for the induction of the Coriolis force with a minimum energy expenditure. The oscillations executed by the measurement tube have a certain form, which is called a natural form of the respective excitation. Another reason for the special importance of natural frequencies in Coriolis mass flow meters is the direct physical linkage between the natural frequency of the measurement tube through which flow has taken place and the effectively deflected oscillation mass (the measurement tube and mass of the medium in the measurement tube). The density of the medium can be determined via this relationship.

It is known from the prior art that, for excitation of the oscillation element by a controller, a harmonic base signal is generated as a controller output signal in the form of a sinusoidal voltage and this sinusoidal voltage triggers the electrical actuating apparatus. The electrical actuating apparatus is designed to make available at its output a corresponding power to trigger the electromagnetic drive in a suitable manner and with sufficient power. The electrical actuating apparatus is thus, essentially, the power linkage element between the controller and the electromagnetic drive of the resonance measuring system. Conventionally, known Coriolis mass flow meters are also equipped with an oscillation transducer with which the oscillation of the oscillation element is detected since, in the oscillation of the oscillation element which is interacting with the medium, there is conventionally the physical information of interest about the medium, for example the flow rate, density and viscosity.

Conventionally the controller is used to drive the oscillation element into resonance, for which it must be determined whether the input quantity and output quantity of the oscillation element have a phase difference corresponding to the resonance. In the case of the Coriolis mass flow meter on the input side, this is the force with which the measurement tube as the oscillation element is excited and, on the output side, this is the speed of the measurement tube. Based on the relationships underlying this oscillatory system there is resonance when the input-side force action and the output-side measurement tube speed have a phase difference of 0°. If this phase condition is satisfied, the desired resonance is present. For this reason, the control circuit for operating a resonance measuring system which is known from the prior art is, in any case, also a phase locked loop.

The “operation of a resonance measuring system” however must relate not only to the standard application of excitation of the oscillation element in the resonance frequency, rather it can also be desirable to excite the oscillation element with another frequency. For example, for selective parameter identification, as is known for example from German Patent DE 10 2008 059 920 A1, which corresponds to U.S. Pat. No. 8,104,361 B2. Here, certain properties of the oscillation behavior of the resonance measuring system are used to be able to identify especially easily determined parameters—in the ideal case only one parameter—of the resonance measuring system for certain steady-state phase angles between the excitation signal and the reaction signal. It can be, for example, desirable to evaluate the mathematical model of the resonance system (generally, therefore, transfer functions for certain modeled and excited natural forms) only for certain steady-state phases, for example for the phases −45°, 0° and +45°. The mathematical models used for operating a resonance measuring system in the prior art are often structure-mechanical models of the oscillation element, which leads, according to equations, to transfer functions of the second order, and which describe the oscillation behavior of certain excited modes. In this respect, reference is also made to German Patent DE 10 2005 013 770 A1, which corresponds to U.S. Pat. No. 7,318,356 B2.

The identification of parameters of the mathematical model of the resonance measuring system and, thus, of the resonance measuring system itself is of great interest for different technical applications. On one hand, the parameters which are relevant for the physical behavior of the resonance system, (such as, for example, the oscillation mass of the oscillation element, the spring stiffness of the oscillation element and the attenuation of the oscillation element), provide an overview of the state of the resonance measuring system. For example, after completion of the resonance measuring system, an assessment is possible about whether the properties of the finished resonance measuring system are within certain tolerances (quality assurance). The repeated measurement or determination of the system parameters using the mathematical model in an operation/installation state can also be used to determine a change of the system behavior of the resonance measuring system, possible errors, and accompanying defects, which can be deduced so that operation of a resonance measuring system also includes the diagnosis, for example. Another application for the initial and continuing determination of certain system parameters is, however, also the online correction of the measurement by considering the altered parameters of the resonance measuring system in the computation.

In all these cases of operation of the resonance measuring system, the accuracy of the identification of the measurement parameters, of the computation of the actual measurement value, and of the diagnosis depends essentially on how accurately the working point of the resonance measuring system, which also lies on the other side of the resonance point, can be set and determined, how exact, therefore, the phase is between the signal which deflects the resonance measuring system and the reaction signal. In the case of a Coriolis mass flow meter, as indicated above, the deflecting quantity is the force that is applied by the oscillation generator to the oscillation element and the reaction quantity is the deflection of the measurement tube or, more often, the first time derivative of the deflection, and therefore, the speed of the measurement tube. In the case of resonance the phase difference between the force acting on the measurement tube and the measurement tube speed is 0°.

In practice, it was ascertained that the exact adjustment of a given phase difference between the force which excites the oscillation element and the reaction quantity of the oscillation element of interest (in the case of a Coriolis mass flow meter, the measurement tube speed) can pose major problems and not only in transient processes, when the natural frequency of the oscillation element changes, for example, with varying densities of the medium, but also for steady states of the resonance measuring system.

### SUMMARY OF THE INVENTION

The object of this invention is to devise a method for operating a resonance measuring system, and a resonance measuring system with which a desired operating point of the resonance measuring system can be achieved with higher precision, so that overall a more precise determination of system parameters, a more precise determination of measurement values, and a more precise diagnosis of the resonance measuring system are possible.

The aforementioned object in the initially described method for operating a resonance measuring system is, first of all, essentially achieved in that, with the mathematical model, at least the electromagnetic drive and the oscillation element, which is interacting with the medium, are depicted; that the driving terminal current of the electromagnetic drive caused by the electrical excitation signal and the driving terminal voltage of the electromagnetic drive caused by the electrical excitation signal are detected by measurement; and that the parameters of the electromagnetic drive and of the oscillation element are identified, at least in part, by evaluation of the mathematical model with the detected driving terminal current i_{DrA} and with the detected driving terminal voltage of the electromagnetic drive.

The invention is based, in particular, on the finding that the phase of interest, for the resonance measuring systems being examined here, between the force excitation of the oscillation element and of the reaction quantity of the oscillation element, therefore the deflection or deflection rate of the oscillation element, in known methods is detected only with insufficient accuracy. This is due especially to lack of consideration of the particulars of the electromagnetic drive, for which reason the electromagnetic drive, in accordance with the invention, is necessarily taken into the mathematical model that is used for operating the resonance measuring system.

The invention is based especially on the finding that the assumption which was made often in the prior art, that the phase of force excitation of the oscillation element is identical to the phase of the current flowing into the electromagnetic drive (driving terminal current) is identical, is insufficient and subject to errors. This often leads to an imprecise adjustment to the desired working point, to inaccurate parameter determinations, and to imprecise diagnosis in the operation of the resonance measuring system. The error made by the above-described assumption generally does not have such an effect that operation of the resonance measuring system is fundamentally not possible, but the deviations from the desired phase angle can be several degrees, which has an adverse effect on the operation of the resonance measuring system.

The assumption that the force acting on the oscillation element is exactly in phase with the current flowing into the electromagnetic drive, therefore, with the driving terminal current, is often not satisfied, for example due to the eddy current losses in the electromagnetic drive itself. In addition, for example, in voltage-controlled voltage sources, as the electrical actuating apparatus for triggering the oscillation generators, the phase angle of the driving terminal current of the electromagnetic drive is strongly influenced by the induced voltage on the drive coil of the electromagnetic drive based on the oscillation of the oscillation element. As a result, therefore, it has been recognized that a direct measurement of the phase angle of the force, which is responsible for the deflection of the oscillation element, is not easily possible since the force, as a measurement quantity, is not accessible without greater measurement engineering effort and the indirect determination via the driving terminal current (without considering the physical characteristics of the electromagnetic drive) is insufficient. For such reason, in accordance with the invention, with the mathematical model not only the oscillation element which interacts with the medium, but at least also the electromagnetic drive is depicted. “Depicted” is defined here in the sense of “considered according to equations in the mathematical model”.

In order to draw conclusions about the internal current of interest for the force action by the drive coil of the electromagnetic drive based on the model part relating to the electromagnetic drive, the driving terminal current caused by the electrical excitation signal and the driving terminal voltage caused by the electrical excitation signal of the electrical actuating apparatus are detected by measurement, which is very easily possible in the resonance measuring system by measurement engineering. For example by direct high-resistance tapping of the driving terminal voltage and by tapping the voltage on a shunt resistance intended for this purpose. In this way, fundamentally, it becomes possible for the parameters of the electromagnetic drive which have been incorporated into the mathematical model—and of course also of the oscillation element—to be identified by evaluating the mathematical model using the driving terminal voltage which has been detected using measurement engineering and of the driving terminal current, which has been detected using measurement engineering.

One preferred configuration of the method in accordance with the invention is characterized in that the mathematical model depicts the electromagnetic drive and the oscillation element interacting with the medium altogether as the load of the electrical actuating apparatus, the load corresponding to the ratio of the driving terminal voltage, and the driving terminal current. Although the model, thus, takes into account the overall electrical aspects of the electromagnetic drive, the mechanical aspects of the oscillation element as well as the mechanical aspects of the medium (in the case of Coriolis mass flow meter the flow-mechanical aspects of the medium), the model from the viewpoint of the electrical actuating apparatus seems more or less an electrical model. It being advantageous to formulate the mathematical model of the electromagnetic drive and of the oscillation element interacting with the medium in the case of a harmonic excitation as a complex-value model since, here, the examination and study of the phase angles of different quantities to one another is especially easily possible.

In one especially preferred configuration of the method in accordance with the invention, the mathematical model is set up such that as parameters of the electromagnetic drive, it comprises the inductance of the drive coil encompassed by the electromagnetic drive, the ohmic resistance of this drive coil, and, preferably, also an ohmic resistance for simulating eddy current losses in the electromagnetic drive. Depending on the electromagnetic drive used, the eddy current losses are possibly negligible so that the ohmic resistance is eliminated.

As parameters of the oscillation element, the mathematical model preferably has the effective oscillation mass m, the effective spring stiffness, and the effective attenuation coefficient d. The effective oscillation mass m is defined as the overall oscillating mass which, depending on the type of resonance measuring system used, is not only the mass of the oscillation element itself. In Coriolis mass flow meters, the effective oscillation mass m is the mass of the oscillating Coriolis measurement tube and the mass of the medium which is carried in it and which is likewise deflected. The same applies to the effective spring stiffness c, which in the case of a Coriolis measurement tube as an oscillation element, is defined as the spring stiffness of the measurement tube or of the measurement tube and of the medium. The same applies to the effective attenuation coefficient which, in the case of a Coriolis mass flow meter, considers the attenuation of the measurement tubes themselves, the attenuation of the measurement medium, and therefore the process-dictated attenuation. For resonance measuring systems, the aforementioned parameters for the oscillation element generally go into a second order equation, different formulations of the mathematical model for the oscillation element being possible when, for example, different oscillation modes are excited.

So that the mathematical model, from the viewpoint of the electrical actuating apparatus, is represented as a load which derives not only from part of the electromagnetic drive, there is also coupling between the model of the electromagnetic drive and of the oscillation element. In the simplest case, for this purpose a transfer coefficient is introduced which comprises the coupling between the electromagnetic drive and the oscillation element. The transfer coefficient, then, preferably indicates the ratio between the force acting on the oscillation element and the current through the drive coil which has the inductance and/or the ratio between the speed-proportional induction voltage on the drive coil and the speed of the oscillation element. It is important here that the current through the inductance is in fact the portion of the current which develops the action of the force on the oscillation element. It in no way needs to be identical or be in phase with the driving terminal current.

The consideration of the induction voltage, which describes the reaction of the moving oscillation element on the drive coil, is also of special importance. The induction voltage is, thus, practically a voltage source that is caused by the movement of the oscillation element, and here, ideally a direct proportionality between the speed of the measurement tube and the induced voltage can be assumed. The ratio of the force acting on the oscillation element to the current causing this force through the coil inductance from which ohmic effects have been removed in the model corresponds to the ratio of the voltage, which has been induced in the drive coil, to the speed v of the measurement tube, which causes this induced voltage. Thus, here, ideally, identical transfer coefficients are present or there is a single transfer coefficient. The transfer coefficient is, thus, essentially the coupling factor which mediates between the mathematical model of the electromagnetic drive and the mathematical model of the oscillation element.

In another configuration of the method in accordance with the invention, to identify the ohmic resistance of the electromagnetic drive, the electromagnetic drive is supplied with a direct signal, for example, a DC voltage, as the electrical excitation signal so that all transient effects can remain ignored. The ohmic resistance follows simply from the quotient of the driving terminal voltage and the driving terminal current.

According to one further configuration of the method, to determine the ohmic resistance and the inductance, which are responsible for the eddy current losses, the drive coil of the electromagnetic drive is supplied with an alternating signal with a frequency that is very much smaller than the natural frequency ω₀ in the resonance operation case as an electrical excitation signal. As a result, the effect of the induced voltage can be ignored. The ohmic resistance of the electromagnetic drive must of course continue to be considered.

In one quite especially advantageous configuration of the method in accordance with the invention, it is provided that at least with the parameterized mathematical model for the electromagnetic drive using the detected driving terminal current and the detected driving terminal voltage, the induced voltage and the current are computed at least with respect to the phase, with which two quantities that are important for operation of a resonance measuring system are available; especially because the computed coil current is related to the direct force action and because the computed induced voltage is directly related to the deflection speed v of the oscillation element. Both quantities together provide a complete outline of the state of operation and of motion of the resonance measuring system.

The possibility of computing the current through the “model coil” is, therefore, notable because effects within the electromagnetic drive which cause a deviation from the driving terminal current can be considered by the model so that at least there is an exact idea about the phase angle of the force applied by the electromagnetic drive to the oscillation element with means which are very simple to implement. Thus, the detection of the force is possible without essentially any additional measurement engineering effort. Therefore, a quantity is detected whose direct measurement would be associated with considerable effort.

It is furthermore notable that, by computing the induced voltage, there is likewise a very exact idea about the speed of the oscillation element, and especially about the phase angle of the speed, which is of priority importance for the operation of the resonance measuring system. The amount of speed is not of tremendous importance for phase control. This information about the speed of the oscillation element is available without a separate transducer for the measurement tube speed or the measurement tube deflection being necessary. This enables many opportunities for a new configuration of resonance measuring systems (e.g., omitting oscillation transducers) and for the additional monitoring of known resonance measuring systems with oscillation transducers, for example, by comparison of two values which have been acquired independently of one another for the speed of the oscillation element.

For many resonance measuring systems, the phase difference between the force acting on the oscillation transducer and the resulting speed of the oscillation element is important since it is a direct measurement for the deviation from the resonance point. With the method in accordance with the invention, preferably, the phase difference between the computed current and the computed induced voltage is computed since this phase difference contains exactly the desired phase information. In order to implement, phase control for example, the resonance measuring system in a continued development of the method in accordance with the invention is first provided with a controller and a difference from a given phase difference and the actual phase difference as the control deviation is made available to the controller. The controller then generates a controller output signal for triggering the electrical actuating apparatus.

In another preferred configuration of the method, it is provided that the resonance measuring system is additionally equipped with an oscillation transducer which detects the excited oscillation of the oscillation element and outputs it as at least one output signal. Preferably, a transducer speed is indirectly determined from the output signal if it is not already a speed signal anyway, at least, with respect to the phase for the speed of the oscillation element. This measure then makes it possible to compare to one another the induced voltage and the transducer speed, at least with respect to their phase. For example, when a given maximum phase deviation is exceeded, a noise signal is output since there apparently is an error as a result. As such, a diagnosis possibility for the resonance measuring system is created by a redundancy which can be implemented without additional hardware cost.

In one alternative version of the method, the phase difference between the computed current and the transducer speed can also be computed, which may be advantageous when the transducer speed has a higher quality than the computed induced voltage. Then it is a good idea to make available to the additional controller a difference from an in turn given phase difference and the phase difference as the control deviation. The controller then generates a controller output signal for triggering the electrical actuating apparatus. The given phase difference (known fundamentally from the prior art for a phase locked loops) is then chosen such that the desired operating state of the resonance measuring system is adjusted, for Coriolis mass flow meters; for example, 0° for the resonance case and ±45° for frequency-selective parameter identification.

The invention, moreover, relates to a resonance measuring system, especially a Coriolis mass flow meter, in which the resonance measuring system has at least one controller, at least one electrical actuating apparatus, at least one electromagnetic drive as an oscillation generator, and at least one oscillation element. In the operation of the resonance measuring system, the controller generates a controller output signal u₁ for triggering the electrical actuating apparatus. The electrical actuating apparatus makes available an electrical excitation signal u₂ for excitation of the electromagnetic drive. The electromagnetic drive excites the oscillation element to oscillation in at least one natural form. A mathematical model of the resonance measuring system, which depicts at least the oscillation element, is computed by a computer unit and the parameters of the mathematical model are identified by suitable excitation of the oscillation element and evaluation of the mathematical model and the identified parameters and/or quantities derived therefrom are used to operate the resonance measuring system. A control circuit is implemented such that it executes the above-described method and the versions of the above-described method. The implementation of the method on the resonance measuring system takes place with a computer unit, for example with a digital signal processor which has the advantage of having many of the required elements such as A/D converter, D/A converter, multiplexer and also signal processing functions.

In particular, there are various possibilities for embodying and developing the method in accordance with the invention and the resonance measuring system in accordance with the invention. In this regard, reference is made to the description of preferred exemplary embodiments in conjunction with the accompanying drawings.

### BRIEF DESCRIPTION OF THE DRAWINGS

FIG. 1 schematically shows the structure of a resonance measuring system in the form of a Coriolis mass flow meter as is known from the prior art, but as could be used also for the method in accordance with the invention.

FIG. 2 shows the equivalent circuit diagram of the mathematical model of an electromagnetic drive and coupled oscillation element in the form of a measurement tube.

FIG. 3 shows one exemplary embodiment of a method in accordance with the invention for operating a resonance measuring system, in a block diagram.

FIG. 4 shows an expanded exemplary embodiment of a method in accordance with the invention for operating a resonance measuring system, likewise in a block diagram.

### DETAILED DESCRIPTION OF THE INVENTION

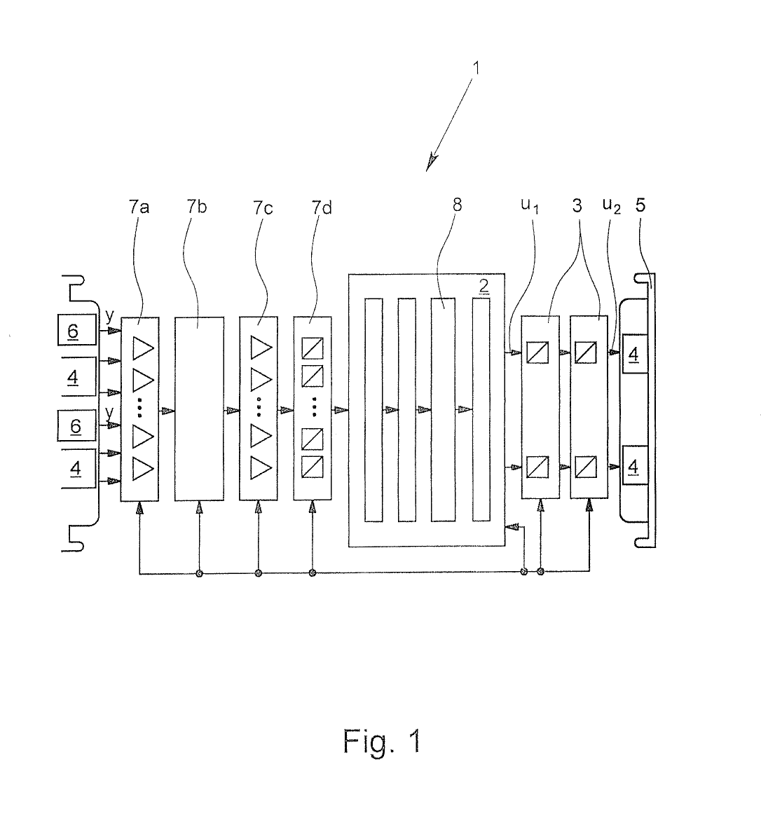

FIG. 1 shows a resonance measuring system 1 in the form of a Coriolis mass flow meter, the resonance measuring system 1 having a controller 2 implemented in a signal processor, an electrical actuating apparatus 3 and an electromagnetic drive 4 as the oscillation generator.

The electromagnetic drive 4 is designed to excite an oscillation element 5 (here, a measurement tube through which a medium can flow), to an oscillation in a natural form. Depending on the type of natural form, only one single electromagnetic drive 4 is necessary. If higher modes are also to be excited, two or more electromagnetic drives 4 can also be necessary, which is not important for the method described below for operating the resonance measuring system 1.

FIG. 1 shows the resonance measuring system 1 in the form of the Coriolis mass flow meter divided into two parts. The Coriolis mass flow meter, which actually forms one unit, ends one half on the right edge of the figure and for reasons of clarity begins with the other half again on the left edge of the figure. It can be recognized that the resonance measuring system 1 also has oscillation transducers 6 which output an output signal y (here, in the form of a speed signal y), which provides information about the speed of the measurement tube motion and, therefore, of the oscillation element 5. The oscillation transducer 6 is not critically necessary for executing the method described below. The oscillation transducers 6 are connected to a plurality of transmission elements which are used essentially for signal conditioning, such as matching electronics 7a consisting of amplifiers, a hardware multiplexer 7b for implementing various switchable measurement channels, further matching electronics 7c, and an analog/digital converter 7d which again supplies the analog measured signals to the controller 2 in the form of digital signals. The controller 2 generates a controller output signal u₁ for triggering the electrical actuating apparatus 3, and the electrical actuating apparatus 3 then generates an electrical excitation signal u₂ for excitation of the electromagnetic drive 4.

Various methods are known in which a mathematical model 8 of the resonance measuring system 1, which depicts the oscillation element 5, is set up and parameters of the mathematical model 8 are identified by suitable excitations of the oscillation element 5 and evaluation of the mathematical model 8 and the identified parameters and/or quantities derived therefrom are used for operating the resonance measuring system 1. The mathematical model 8 is shown in FIG. 1 as a component of the controller 2, all methods for operating the Coriolis mass flow meter being essentially implemented in the form of programs on one or more computer units.

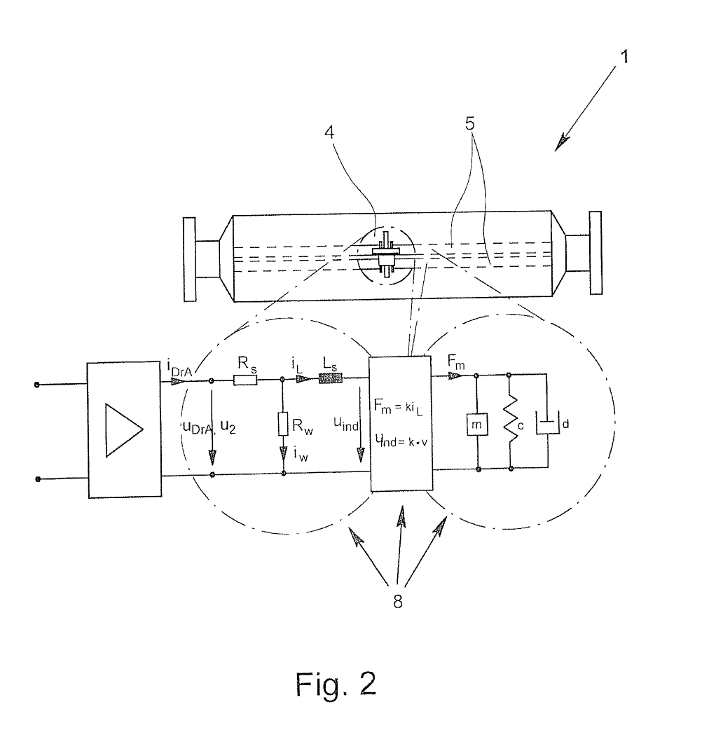

FIG. 2 shows, in the form of an equivalent circuit diagram, the method in accordance with the invention for operating the resonance measuring system 1. In the upper section of FIG. 2 first a Coriolis mass flow meter is sketched as the resonance measuring system 1, and two measurement tubes are indicated as the oscillation element 5. Furthermore, an electromagnetic drive 4 is indicated with which the measurement tubes can be deflected against one another and, thus, can be excited to oscillation. In the lower part of FIG. 2 the implemented equivalent circuit diagram for the electromagnetic drive 4 (left side) and for the oscillation element 5 which interacts with the medium (right side) are shown so that the electromagnetic drive 4 and the oscillation element 5 are altogether depicted with the mathematical model 8 in the form of the equivalent circuit diagram. Furthermore, it is shown that the electrical actuating apparatus 3 generates an electrical excitation signal u₂ for excitation of the electromagnetic drive 4.

The driving terminal current i_{DrA} caused by the electrical excitation signal u₂ and the driving terminal voltage u_{DrA} of the electromagnetic drive 4 caused by the electrical excitation signal u₂ is detected by measurements, which is not particularly shown here. The electrical excitation signal u₂ is identical to the driving terminal voltage u_{DrA} since the electrical actuating apparatus 3 is a voltage-controlled voltage converter. The driving terminal current i_{DrA} can be tapped, for example, by the voltage drop on an ohmic resistance. The driving terminal voltage u_{DrA} can be detected at high resistance directly from one analog measurement input of a digital signal processor or can be digitized by a separate analog/digital converter.

In contrast to other mathematical models known from the prior art, the mathematical model 8 also simulates the physical properties of the electromagnetic drive 4, so that effects of the electromagnetic drive 4 which have not been considered to date can also be included in the computation. In this case, the parameters of the electromagnetic drive 4 and of the oscillation element 5 are identified by evaluating the mathematical model 8 with the driving terminal current i_{DrA}, which was detected by measurement engineering and with the detected driving terminal voltage u_{DrA} of the electromagnetic drive 4.

It is apparent from the mathematical model 8, which is shown in FIG. 2 in the form of an equivalent circuit diagram, that the mathematical model 8 depicts the electromagnetic drive 4 and the oscillation element 5, which interacts with the medium overall as a load of the electrical actuating apparatus 3. The load corresponds to the ratio of the driving terminal voltage u_{DrA} and the driving terminal current i_{DrA}. The following applies:

$$Z ( jω ) = \frac{{U}_{DrA} ( jω )}{{I}_{DrA} ( jω )} \qquad ( 1 )$$

In the aforementioned description according to equations it is assumed that the electrical excitation signal u₂ is a harmonic excitation signal so that the complex-value formulation is presented. It is clear from examining FIG. 2 that the complex resistance is altogether dependent on the properties of the oscillation generator 4 (inductance of the coil, ohmic resistance of the coil and eddy current losses), on the mechanical properties of the oscillation element 5 in the form of measurement tubes, and also on the properties of the medium which is interacting with the oscillation element 5, here on the medium which is flowing through the measurement tubes. The complex resistance is therefore dependent on the electrical, mechanical, and flow-mechanical properties of the electromagnetic drive 4 and of the oscillation element 5 which interacts with the medium.

In the equivalent circuit diagram shown in FIG. 2 the equivalent quantities altogether have the following meaning:
u_{DrA}:=voltage at the output of the power amplifier (voltage on the drive coil),
i_{DrA}:=current at the output of the power amplifier (current through the drive coil),
i_{L}:=current through the equivalent inductance,
k:=transfer coefficient,
R_{S}:=ohmic resistance of the drive coil,
R_{W}:=eddy current losses in the electromagnetic drive,
L_{S}:=inductance of the drive coil,
u_{ind}:=speed-proportional induction voltage on the coil,
v:=measurement tube speed,
m:=oscillation mass of the measurement tubes and of the measurement medium (effectively oscillating mass),
c:=spring stiffness of the measurement tubes and of the measurement medium (effective spring stiffness),
d:=attenuation coefficient of the measurement tubes and of the measurement medium (process-dictated attenuation), and
Fₘ=driving force.

The resistance R_{S} describes the ohmic resistance of the drive coil encompassed by the electromagnetic drive 4. The resistance R_{W} describes the eddy current losses in the electromagnetic oscillation generator and the inductance of the drive coil is described by L_{S}. For the assessment of the state of motion of the resonance system 1, the phase angle between the current i_{L} through the inductance L_{S} and the speed of the oscillation element 5 is of special interest. The current i_{L} flowing exclusively through the inductance L_{S} causes a proportion force action Fₘ on the oscillation element 5. It is immediately apparent from the equivalent circuit diagram according to FIG. 2 that the current i_{L} need not be in phase to the driving terminal current i_{DrA}. To compute the complex load according to equation (1) the following equations can be derived from FIG. 2:

$${u}_{DrA} = {R}_{S} {i}_{DrA} + {R}_{W} {i}_{W} \\ {u}_{DrA} = {R}_{S} {i}_{DrA} + {L}_{S} \frac{d {i}_{L}}{d t} + {u}_{ind} \\ {i}_{DrA} = {i}_{L} + {i}_{W} \\ {F}_{m} = m \dot{v} + dv + c \int v d τ \\ {F}_{m} = {ki}_{L} \\ {u}_{ind} = kv \qquad ( 2 )$$

The transfer coefficient k couples the partial mathematical models for the electromagnetic drive 4 and the oscillation element 5 to one another. Equally there is a proportionality between the current i_{L} through the coil in the equivalent circuit diagram with the inductance L_{S} and the force action Fₘ caused thereby, on one hand, as on the other, between the speed v of the measurement tube as the oscillation element 5 and the reaction caused by the latter in the form of the induced voltage u_{ind}. Since both actions are produced by the same electromagnetic drive 4, in fact, the same transfer coefficient k applies to both equations. The transfer coefficient k is not critically necessary as an absolute value for determining many quantities of interest because often only relations of values to one another are considered, because certain values are only of interest with respect to their phase angle, less to their amount, and because in practice corresponding values for k can be determined in an initial calibration. Likewise, it is of course possible to give an exact value for k even if the determination also means a certain measurement engineering effort.

Depending on whether the electrical actuating apparatus 3 at its output drives a current or a voltage and, accordingly, either the driving terminal current i_{DrA} or the driving terminal voltage u_{DrA} is set as the output quantity, the transfer functions are different. For the case in which the driving terminal current i_{DrA} is set as a reaction to a driving terminal voltage u_{DrA} which is delivered by the electrical actuating apparatus (U-U power amplifier), the admittance in the image range (equation 3) is:

$$\frac{{I}_{DrA}}{{U}_{DrA}} = G = \frac{1}{( {R}_{S} + {R}_{W} )} \cdot \frac{{L}_{S} {ms}^{3} + ( {L}_{S} d + {R}_{W} m ) {s}^{2} + ( {L}_{S} c + {R}_{W} d + {k}^{2} ) s + {R}_{W} c}{{L}_{S} {ms}^{3} + ( \begin{matrix}{L}_{S} d + \\ ( {R}_{W} \vert \vert {R}_{S} ) m\end{matrix} ) {s}^{2} + ( \begin{matrix}{L}_{S} c + {k}^{2} + \\ ( {R}_{W} \vert \vert {R}_{S} ) d\end{matrix} ) s + ( {R}_{W} \vert \vert {R}_{S} ) c} . \qquad ( 3 )$$

For the case in which the electrical actuating apparatus 3 drives the driving terminal current i_{DrA} and the driving terminal voltage is set as a reaction, for the complex resistance (the electrical actuating apparatus 3 works as U-I power amplifier):

$$\frac{{U}_{DrA}}{{I}_{DrA}} = Z = ( {R}_{S} + {R}_{W} ) \cdot \frac{{L}_{S} {ms}^{3} + ( \begin{matrix}{L}_{S} d + \\ ( {R}_{W} \vert \vert {R}_{S} ) m\end{matrix} ) {s}^{2} + ( \begin{matrix}{L}_{S} c + {k}^{2} + \\ ( {R}_{W} \vert \vert {R}_{S} ) d\end{matrix} ) s + ( {R}_{W} \vert \vert {R}_{S} ) c}{{L}_{S} {ms}^{3} + ( {L}_{S} d + {R}_{W} m ) {s}^{2} + ( {L}_{S} c + {R}_{W} d + {k}^{2} ) s + {R}_{W} c} . \qquad ( 4 )$$

The two transfer functions describe the complex admittance G and the complex resistance Z with which the electrical actuator apparatus 3 is altogether loaded, therefore electrically, mechanically and flow-mechanically. The parameters of the transfer functions can be identified in a very different manner, for example by the transfer functions being examined at different frequencies and at these frequencies measured values for the driving terminal current i_{DrA} and the driving terminal voltage u_{DrA} being detected and used for evaluation of the equations and thus of the mathematical model 8.

In the excitation of the resonance measuring system with a direct signal the ohmic resistance of the electrical actuator apparatus 3 can be determined. For ω=0 it follows from equation (3) for example:

$$\frac{{I}_{DrA 0}}{{U}_{DrA 0}} = \frac{1}{( {R}_{S} + {R}_{W} )} \cdot \frac{{R}_{W} c}{( {R}_{W} \vert \vert {R}_{S} ) c} = \frac{1}{{R}_{S}} ⇒ {R}_{S} = \frac{{U}_{DrA 0}}{{I}_{DrA 0}} \qquad ( 5 )$$

It is shown below how the induced voltage u_{ind} and the current i_{L} can be computed with the mathematical model 8 resulting from equation (3) using the detected driving terminal current i_{DrA} and the detected driving terminal voltage u_{DrA}. To do this the electromagnetic drive 4 is excited with a frequency which is very small, especially very much smaller than the first natural frequency of the system. This measure ensures that the voltage u_{ind} induced by the motion of the measurement tube in the coil of the electromagnetic drive is essentially negligible so that u_{ind}=0 applies; it follows therefrom:

$$\frac{{\underline{U}}_{DrA 1}}{{\underline{I}}_{DrA 1}} = {R}_{S} + \frac{{R}_{W} \cdot {jω}_{Z 1} {L}_{S}}{{R}_{W} + {jω}_{Z 1} {L}_{S}} ⇒ \\ \frac{{\underline{U}}_{DrA 1}}{{\underline{I}}_{DrA 1}} - {R}_{S} = \frac{{R}_{W} \cdot {jω}_{Z 1} {L}_{S}}{{R}_{W} + {jω}_{Z 1} {L}_{S}} ⇒ . \\ \frac{1}{\frac{{\underline{U}}_{DrA 1}}{{\underline{I}}_{DrA 1}} - {R}_{S}} = \frac{1}{{jω}_{Z 1} {L}_{S}} + \frac{1}{{R}_{W}} \qquad ( 6 )$$

With the agreement

$${Z}_{1} = \frac{{U}_{DrA 1}}{{I}_{DrA 1}} , {Z}_{1 R} = Re \{ {Z}_{1} \} , {Z}_{1 t} = Im \{ {Z}_{1} \}$$

it then follows:

$$\frac{1}{Re \{ {Z}_{1} \} + jIm \{ {Z}_{1} \} - {R}_{S}} = \frac{1}{{jω}_{Z 1} {L}_{S}} + \frac{1}{{R}_{W}} \\ \frac{Re \{ {Z}_{1} \} - {R}_{S} - jIm \{ {Z}_{1} \}}{{( Re \{ {Z}_{1} \} - {R}_{S} )}^{2} + {( Im \{ {Z}_{1} \} )}^{2}} = \frac{1}{{jω}_{Z 1} {L}_{S}} + \frac{1}{{R}_{W}} , \qquad ( 7 )$$

and, thus first of all, determination equations for the ohmic resistance R_{W} for simulating eddy current losses and for the inductance L_{S} of the coil of the electromagnetic drive:

$${R}_{W} = \frac{{( Re \{ {Z}_{1} \} - {R}_{S} )}^{2} + {( Im \{ {Z}_{1} \} )}^{2}}{Re \{ {Z}_{1} \} - {R}_{S}} \\ {L}_{S} = \frac{1}{{ω}_{Z 1}} \cdot \frac{{( Re \{ {Z}_{1} \} - {R}_{S} )}^{2} + {( Im \{ {Z}_{1} \} )}^{2}}{Im \{ {Z}_{1} \}} \qquad ( 8 )$$

If the parameters R_{S}, R_{W} and L_{S} have been determined as proposed above, the induced voltage u_{ind} and the current i_{L} through the coil of the equivalent circuit diagram can be computed via the measured driving terminal voltage u_{DrA} and the measured driving terminal current i_{DrA}:

$$\begin{matrix}{i}_{L} = ( 1 + \frac{{R}_{S}}{{R}_{W}} ) {i}_{DrA} - \frac{{u}_{DrA}}{{R}_{W}} \\ and & ( 9 ) \\ {u}_{ind} = {u}_{DrA} - {R}_{S} {i}_{DrA} - {L}_{S} \frac{d}{d t} ( {i}_{DrA} - \frac{{u}_{DrA} - {R}_{S} {i}_{DrA}}{{R}_{W}} ) . & ( 10 )\end{matrix}$$

It must be considered that the current i_{L} and the induced voltage u_{ind} are likewise quantities which are in a certain phase relative to one another. With a harmonic excitation also, the current i_{L} and the voltage u_{ind} will again be harmonic values which can be treated mathematically especially easily as complex vectors. Therefore, the phase angle of the induced voltage (and thus the phase angle of the speed), and the phase angle of the current i_{L} (and thus the phase angle of the force excitation) follow from equations (9) and (10). For the transfer function of interest between the speed of the movement of the oscillation element 5 and the driving force Fₘ there results the following for a harmonic excitation of the system:

$$\begin{matrix}\frac{V}{{F}_{m}} = \frac{\frac{{U}_{ind}}{k}}{{kI}_{L}} = \frac{{U}_{ind}}{{k}^{2} {I}_{L}} . \\ \frac{V}{{F}_{m}} = \frac{\frac{1}{m}}{{( jω )}^{2} + jω \frac{d}{m} + \frac{c}{m}}\end{matrix} \} ⇒ \\ \frac{{U}_{ind}}{{I}_{L}} = \frac{\frac{1}{m} {k}^{2} jω}{{( jω )}^{2} + jω \frac{d}{m} + \frac{c}{m}} \qquad ( 11 )$$

Equation (11) allows the determination of the mechanical system parameters for suitable excitation of the resonance measuring system and using the computed current i_{L} and the computed induced voltage u_{ind}. If the phase shift Δφ(i_{L}, u_{ind}) is set to 0, the oscillation element 5 at its natural frequency ω₀=c/m is excited. Then, the attenuation coefficient d can be determined by the following:

$$d = \frac{{I}_{L} ( {jω}_{0} )}{{k}^{2} {U}_{ind} ( {jω}_{0} )} . \qquad ( 12 )$$

If the resonance measuring system 1, in the form of the illustrated Coriolis mass flow meter, is excited such that the phase shift Δφ(u_{ind}, i_{L}) is +45°, the oscillation element 5 by definition is excited at a frequency ω₊₄₅. It can be derived from equation (11) that the effective spring stiffness c can then be determined as follows via the computed current i_{L} and the computed induced voltage u_{ind} and thus via the measured driving terminal voltage u_{ind} and the measured driving terminal current i_{DrA}:

$$c = \frac{{ω}_{+ 45} {ω}_{01}^{2}}{{ω}_{01}^{2} - {ω}_{+ 45}^{2}} d \\ c = \frac{{ω}_{+ 45} {ω}_{01}^{2}}{{ω}_{01}^{2} - {ω}_{+ 45}^{2}} \cdot \frac{{I}_{L} ( {jω}_{0} )}{{k}^{2} {U}_{ind} ( {jω}_{0} )} \qquad ( 13 )$$

The effectively oscillating mass m can be computed similarly, specifically as follows:

$$m = \frac{{ω}_{+ 45}}{{ω}_{01}^{2} - {ω}_{+ 45}^{2}} \cdot \frac{{I}_{L} ( {jω}_{0} )}{{k}^{2} {U}_{ind} ( {jω}_{0} )} \qquad ( 14 )$$

The parameters which have been determined here by way of example for the effective attenuation constant d, the effectively acting spring stiffness c and the effectively oscillating mass m are all normalized to a constant factor k². As already stated, this factor can be determined if necessary, for example via the use of a compensation balance.

The procedure described here for parameter identification should be understood by way of example and other procedures are easily conceivable. The mathematical model 8 presented can also be used reduced, for example, without the eddy current resistance R_{W}, but the mathematical model 8 can also be supplemented. For parameter identification other frequencies and phase angles can also be used, which can take place in more or less steady state, for multifrequency excitation, and also in a dynamic operating state.

With the illustrated method it is very simple to identify relevant parameters of the mathematical model 8. According to one preferred configuration of the method it is provided that at least one of the identified parameters of the mathematical model 8 of the electromagnetic drive 4 and of the oscillation element 5 is used for product monitoring and/or for maintenance and/or for making available diagnosis data; especially for the parameters used a tolerance band being given and departure from the tolerance band being signaled. For example the inductance L_{S} is identified as the selected parameter of the electromagnetic drive and it is checked whether it is within a predetermined tolerance band. Leaving the tolerance band can be used for example as an indicator of a short circuit in the coil winding. Another example is the effective spring stiffness c of the first natural form of the oscillation element 5. If the identified spring stiffness c from which temperature influences have been removed leaves the predetermined tolerance band, an alarm is output and maintenance is notified for example about the erosion of the oscillation element 5 (measurement tube). Under certain assumptions, even the current wall thickness of the measurement tube can be determined and displayed.

Moreover, for example, the identified value of the effective spring stiffness c is compared to the value of the spring stiffness c_{cal} in factory calibration and the resulting difference via a predetermined function is used for the correction of the measurement values for the mass flow rate and for the fluid density. In doing so the measurement values of the possibly present temperature sensors and/or wire strain gauges can be considered in order to reduce the measurement uncertainty of the measurement values for the mass flow rate and for the fluid density; the combination of different correction methods is likewise one preferred implementation. Another example is the identification of the attenuation coefficient d and its variance. These values can be used for detection and correction of a multiphase flow.

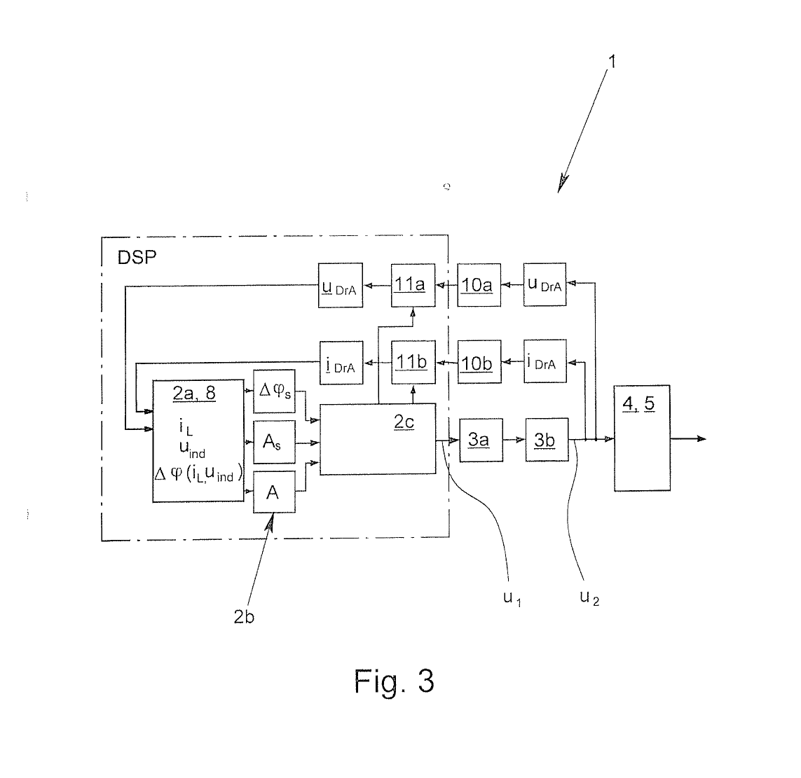

FIG. 3 shows a resonance measurement system 1 in the form of a Coriolis mass flow meter. The resonance measurement system 1 has a controller 2 implemented in a digital signal processor (DSP) and an electrical actuating apparatus 3 with a digital/analog converter 3a, and a voltage-controlled voltage source 3b as the power portion. The electromagnetic drive 4 has a coil which deflects the oscillation element 5 and excites it to oscillations. In the illustrated exemplary embodiment, the electrical excitation signal u₂ which has been generated by the electrical actuating apparatus 3 is a voltage which is equal to the driving terminal voltage u_{DrA} of the electromagnetic drive 4. The driving terminal current i is consequently set according to the impressed voltage u_{DrA}, according to the parameters of the electromagnetic drive 4 and of the oscillation element 5 and according to the state of motion of the oscillation element 5 in conjunction with the medium. The driving terminal voltage u_{DrA} and the driving terminal current i_{DrA} are in any case detected by measurement engineering and converted with analog/digital converters 10a, 10b.

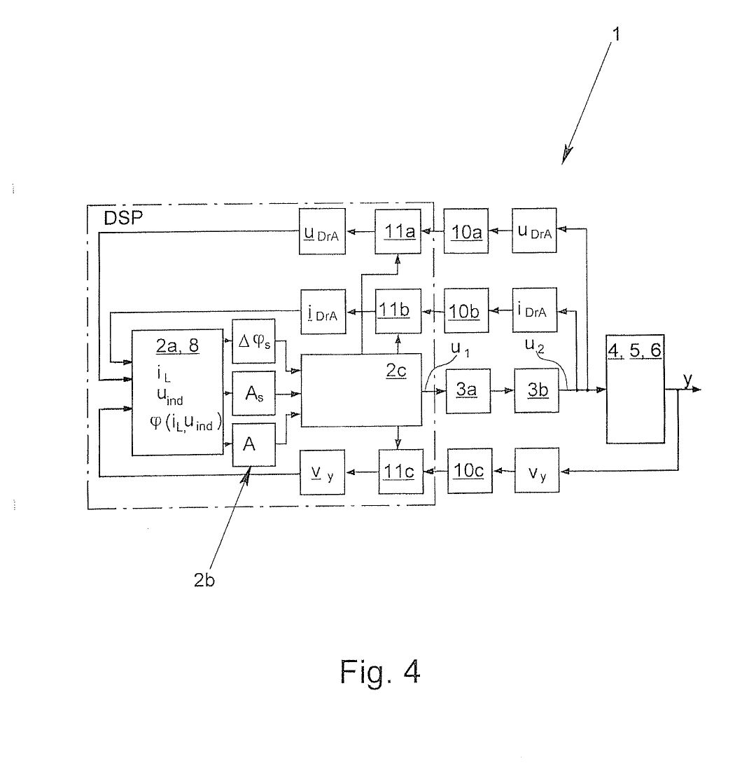

FIG. 3 and FIG. 4 show the controller 2 in pieces. The mathematical model 8 is filed in the controller part 2a so that all computations relating to the model 8 can take place here. In the controller parts 2b the actual controllers are implemented, at the top for example, for phase control, in the middle for amplitude control, and at the bottom for the amplitude control. Outputs of the controller 2b are manipulated variables that are converted by the subsequent signal generator 2c. To excite the oscillation element 5, in the signal generator 2c first two orthogonal harmonic excitation signals are generated from which together the controller output signal u₁ is produced. The likewise harmonic measurement quantities which are supplied again to the DSP via the analog/digital converters 10a, 10b in the demodulators 11a, 11b using the orthogonal base signals of the signal generator 2c are broken down into signal components which allow the determination of the phase angle of the signals with reference to the base signal so that after demodulation there is phase information relative to the output signal of the signal generator 2c. The driving terminal voltage u_{DrA} which is known according to amount and phase and the driving terminal current i_{DrA} are then used by evaluation of the model equations of the mathematical model 8 to compute the coil current i_{L} and the induced voltage u_{ind} as well as their phase angle to one another.

The resonance measuring systems 1 according to FIG. 4, compared to the resonance measuring system according to FIG. 3, also has an oscillation transducer 6 which detects the deflection of the oscillation element 5 by measurement engineering and outputs it as an output signal y. From the deflection the speed signal v_{y} is then determined (if it is not already directly the output signal of the oscillation transducer 6), and the speed signal v_{y} is subsequently digitized by the analog-digital converter 10c and supplied to the DSP. Here, the speed signal is demodulated by a demodulator 11c with reference to the base signal u₁ so that the phase is known with respect to this signal. In contrast to the resonance measuring systems known from the prior art, in the resonance measuring system 1 shown in FIGS. 3 and 4, an oscillation transducer 6 is not critically necessary since the speed information can be obtained from the computed induced voltage u_{ind}. The additional information about the speed signal v_{y} from an additional oscillation transducer 6 can be used to balance speed data acquired in two different ways against one another. In the case of a deviation which lies outside the tolerance band an error signal is output.

What is claimed is:

1. A method for operating a resonance measuring system comprising an electrical actuating apparatus, an electromagnetic drive as an oscillation generator, an oscillation element which interacts with a medium, the method comprising:
providing an electrical excitation signal u₂ for exciting the electromagnetic drive;
exciting by the electromagnetic drive the oscillation element to oscillation in at least one natural form;
depicting by a mathematical model of the resonance measuring system the oscillation element;
identifying parameters of the mathematical model by excitation of the oscillation element and evaluation of the mathematical model;
deriving the identified parameters and/or quantities for operation of the resonance measuring system,
depicting, using the mathematical model, the electromagnetic drive and the oscillation element interacting with the medium;
measuring a driving terminal current caused by the electrical excitation signal and a driving terminal voltage of the electromagnetic drive caused by the electrical excitation signal; and
identifying parameters of the electromagnetic drive and of the oscillation element by evaluation of the mathematical model based on the detected driving terminal current and the detected driving terminal voltage of the electromagnetic drive.

2. The method of claim 1, wherein the mathematical model depicts the electromagnetic drive and the oscillation element which is interacting with the medium as the load of the electrical actuating apparatus, the load corresponding to the ratio of the driving terminal voltage and the driving terminal current.

3. The method of claim 1, wherein:
the parameters of the electromagnetic drive comprise one or more of an inductance of the drive coil, an ohmic resistance of the drive coil, and an ohmic resistance simulating eddy current losses in the electromagnetic drive;
the parameters of the oscillation element comprise one or more of an effective oscillation mass, an effective spring stiffness and an effective attenuation coefficient; and
the mathematical model comprises one or more of a transfer coefficient describing the coupling between the electromagnetic drive and the oscillation element, the transfer coefficient indicating the ratio between a force acting on the oscillation element and the current through the drive coil which has the inductance and/or the ratio between a speed-proportional induction voltage on the drive coil and a speed of the oscillation element.

4. The method recited in claim 1, wherein:
to identify the ohmic resistance of the drive coil, the electromagnetic drive receives a direct signal as the electrical excitation signal; and
to determine the ohmic resistance simulating eddy current losses and the inductance of the drive coil, the electromagnetic drive receives an alternating signal having a frequency that is smaller than a natural frequency during resonance operation as an electrical excitation signal

5. The method recited in claim 1, further comprising computing the mathematical model using the detected driving terminal current and the detected driving terminal voltage, the induced voltage, and the current with respect to a phase difference between the current and induced voltage.

6. The method recited in claim 5, wherein:
the resonance measuring system comprises a controller; and
the method further comprises providing a difference from a given phase difference Δφ_{S1} and the phase difference as the control deviation to the controller; and
generating by the controller a controller output signal for triggering the electrical actuating apparatus.

7. The method recited in claim 3, further comprising:
detecting the excited oscillation of the oscillation element with an oscillation transducer; and
outputting an excited oscillation output signal.

8. The method of claim 7, wherein outputting of the excited oscillation signal comprises determining a transducer speed based on the excited oscillation signal with respect to the phase of the oscillation element.

9. The method recited in claim 8, further comprising:
comparing the speed-proportional induction voltage and the transducer speed to one another with respect to their phase; and
outputting a noise signal when a given maximum phase deviation is exceeded.

10. The method recited in claim 5, further comprising calculating the phase difference between a transducer speed and the computed current.

11. The method recited in claim 10, wherein calculating the phase difference comprises:
providing to the controller a difference from a given phase difference and providing the phase difference as a control deviation; and
generating an output signal for triggering the electrical actuating apparatus with the controller.

12. The method recited in claim 1, wherein the method further comprises using at least one of the identified parameters of the mathematical model of the electromagnetic drive and of the oscillation element for product monitoring, for maintenance, for providing diagnosis data

13. The method of claim 12, wherein the method further comprises comparing the at least one of the identified parameters with a given tolerance band and signaling a departure from the tolerance band.

14. The method recited in claim 1, further comprising:
generating by the controller a harmonic base signal as a controller output signal; and
determining one or more of a phase angle of the driving terminal current or a phase angle of the driving terminal voltage by demodulating the current signal with a harmonic base signal and another harmonic base signal orthogonal thereto which is received from the controller.

15. A resonance measuring system for a Coriolis mass flow meter, the resonance measuring system comprising:
at least one controller;
at least one electrical actuating apparatus;
at least one electromagnetic drive configured as an oscillation generator;
at least one oscillation element; and
a mathematical model of the resonance measuring system,
wherein:
the at least one controller is configured to generate a controller output signal u₁ for triggering the at least one electrical actuating apparatus;
the at least one electrical actuating apparatus is configured to provide an electrical excitation signal u₂ for excitation of the at least one electromagnetic drive; and
the at least one electromagnetic drive is configured to excite the at least one oscillation element to oscillation in at least one natural form;
a mathematical model of the resonance measuring system depicts at least the oscillation element being computed by a computer unit; and
parameters of the mathematical model are identified by excitation of the at least one oscillation element and evaluation of the mathematical model; and
the identified parameters or quantities derived the mathematical model are used to operate the resonance measuring system.

16. The resonance measuring system recited in claim 15, wherein the at least one electrical actuating apparatus is a voltage-controller voltage converter.
